(19) United States
(12) Patent Application Publication
(10) Pub. No.: US 2015/0207877 A1
(43) Pub. Date: Jul. 23, 2015

(54) TIME SYNCHRONIZATION CLIENT, A SYSTEM AND A NON-TRANSITORY COMPUTER READABLE MEDIUM

(71) Applicant: KABUSHIKI KAISHA TOSHIBA, Tokyo (JP)

(72) Inventor: Masashi ITO, Yokohama (JP)

(21) Appl. No.: 14/601,702

(22) Filed: Jan. 21, 2015

(30) Foreign Application Priority Data
Jan. 21, 2014 (JP) 2014-009032

(51) Int. Cl. H04L 29/08; G06F 1/12

(52) U.S. Cl. CPC H04L 67/1095; G06F 1/12

(57) ABSTRACT

A time synchronization client having a timer, transmits request frames to request a reference time to a server having a reference timer, and receives a reply frame of respective request frames from the server. Based on an accuracy of the timer to the reference timer and an allowable time difference therebetween, an allowable measurement period is calculated. For the respective request frames transmitted within the allowable measurement period before a current time of the timer, an estimated time difference therebetween is calculated, based on a first time of the timer when the request frame is transmitted, a second time of the reference timer when the server receives the request frame, a third time of the reference timer when the server transmits the reply frame, and a fourth time of the timer when the reply frame is received. The time of the timer is corrected based on the estimated time difference.

### CROSS-REFERENCE TO RELATED APPLICATION

This application is based upon and claims the benefit of priority from Japanese Patent Application No.2014-009032, filed on Jan. 21, 2014; the entire contents of which are incorporated herein by reference.

### FIELD

Embodiments described herein relate generally to a time synchronization client, a system and a non-transitory computer readable medium.

### BACKGROUND

A time synchronization system including a time synchronization client and a time synchronization server is known. In this system, the time synchronization client communicates the time synchronization server which presents a reference time with high accuracy via a communication network. By this communication, a local time of the time synchronization client is synchronized with the reference time presented by the time synchronization server.

In case of time synchronization, the time synchronization client transmits a synchronization request frame requesting the reference time to the time synchronization server, and receives a synchronization replay frame representing the reference time from the time synchronization server. By adding an estimated communication delay (a half time of a round-trip time between the synchronization request frame and the synchronization reply frame) to the reference time, the time synchronization client estimates a current time of the time synchronization server. The time synchronization client calculates a time difference (it is called “an estimated time difference”) between the estimated current time of the time synchronization server and a local current time of the time synchronization client. By adding the estimated time difference to the local current time of the time synchronization client, the time synchronization client corrects the local current time.

As a method for calculating the estimated time difference, a communication delay is calculated from timestamps included in a synchronization request frame (transmitted within a predetermined period before the current time by the time synchronization client) and a synchronization replay frame thereof. Among communication delays calculated from respective pairs of the synchronization request frame and the synchronization replay frame, by using time information included in one pair of the synchronization request frame and the synchronization replay frame from which a minimum communication delay is calculated, the estimated time difference is calculated. In this method, a small value as the communication delay is used. As a result, a time synchronization error due to queuing of a communication network device can be reduced.

In order to reduce the time synchronization error, above-mentioned predetermined period needs to be suitably determined. If the predetermined period is short, possibility that the communication delay is calculated as a small value is low. If the predetermined period is long, by effect that a difference between the reference time of the time synchronization server and the local time of the time synchronization client, the time synchronization error occurs. Especially, if the predetermined period is too long, the time difference is often over the time synchronization error allowed by the system.

Conventionally, by heuristics or experiments, above-mentioned predetermined period is determined. In case of the heuristics, a large time synchronization error may occur. As a result, the time difference may be over the time synchronization error allowed by the system. Furthermore, in case of the experiments, labor that a long time is taken for the experiment is required for the user. Especially, a suitable predetermined period to reduce the time synchronization error is different by performance of the time synchronization client or the time synchronization server. Accordingly, whenever a component of the time synchronization system is changed, the experiment needs to be performed. As a result, the time and labor are required for the user.

### BRIEF DESCRIPTION OF THE DRAWINGS

FIG. 1 is a block diagram of a system according to embodiments of the present invention.

FIG. 2 is a block diagram of a time synchronization client 100 according to the first embodiment.

FIG. 3 is a block diagram of a time synchronization server 200 according to the first embodiment.

FIG. 4 is a flow chart of operation of the time synchronization client 100 according to the first embodiment.

FIG. 5 is a flow chart of operation to determine a transmission cycle of a synchronization request frame of the time synchronization client 100.

FIG. 6 is a schematic diagram showing relationship among a trial period, an allowable measurement period, and a transmission cycle f of the time synchronization client 100.

FIG. 7 is a block diagram of a time synchronization client 2100 according to the second embodiment.

FIG. 8 is a flow chart of operation of the time synchronization client 2100 according to the second embodiment.

### DETAILED DESCRIPTION

According to one embodiment, a time synchronization client includes a communication unit, a timer, an allowable measurement period calculation unit, an estimated time difference calculation unit, and a correction unit. The communication unit transmits a plurality of request frames to request a notification of a reference time to a server having a reference timer that clocks the reference time, and receives a reply frame as a reply of respective request frames from the server. The timer clocks a time. The allowable measurement period calculation unit calculates an allowable measurement period, based on an accuracy of the timer to the reference timer and an allowable time difference between the timer and the reference timer. The estimated time difference calculation unit calculates an estimated time difference between the timer and the reference timer for the respective request frames transmitted within the allowable measurement period before a current time of the timer, based on a first time of the timer when the communication unit transmits the request frame, a second time of the reference timer when the server receives the request frame, a third time of the reference timer when the server transmits the reply frame, and a fourth time of the timer when the communication unit receives the reply frame. The correction unit corrects the time of the timer, based on the estimated time difference.

Various embodiments will be described hereinafter with reference to the accompanying drawings.

### The First Embodiment

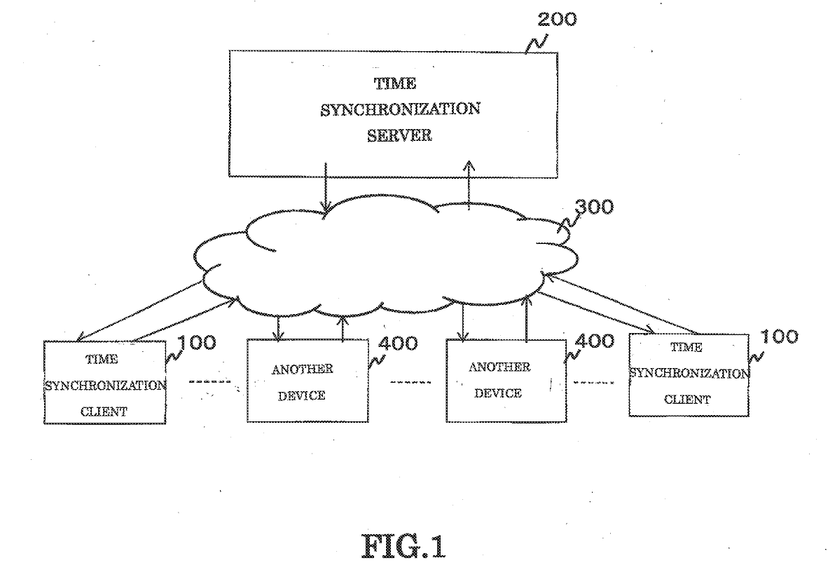

FIG. 1 is a block diagram of a system according to the first embodiment.

The system includes a plurality of time synchronization clients 100, a time synchronization server 200, and a plurality of another devices 400. The time synchronization client 100 communicates the time synchronization server 200 having a time which clocks a reference time via a communication network 300. Here, the communication network 300 may be a wireless network or wired network.

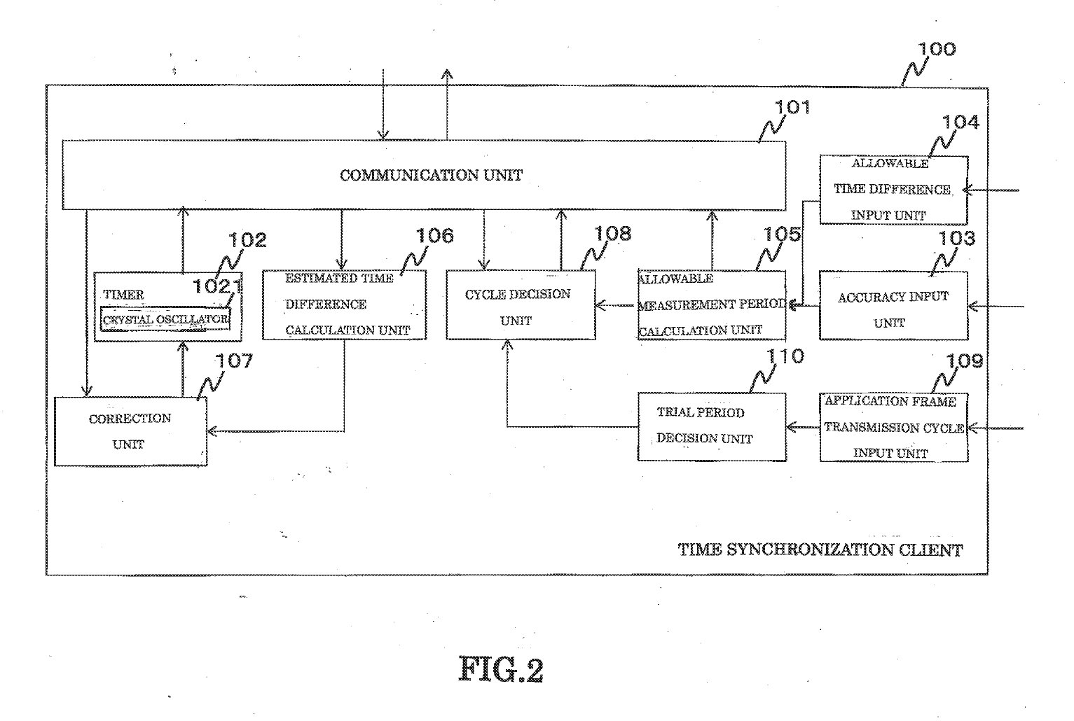

FIG. 2 is a block diagram of the time synchronization client 100.

The time synchronization client 100 includes a communication unit 101, a timer 102, an accuracy input unit 103, an allowable time difference input unit 104, an allowable measurement period calculation unit 105, an estimated time difference calculation unit 106, a correction unit 107, a cycle decision unit 108, an application frame transmission cycle input unit 109, and a trial period decision unit 110. The timer 102 includes a crystal oscillator 1021. In FIG. 1, each unit of the time synchronization client 100 may be realized as a special purpose chip in which each function is previously programmed or as a function that an information processing device such as CPU (Central Processing Unit) executes by reading a program stored in ROM (Read Only Memory) or RAM.

The communication unit 101 transmits a plurality of synchronization request frames requesting a notification of a reference time to the time synchronization server 200. The communication unit 101 receives a synchronization reply frame as a reply for each synchronization request frame. Furthermore, the communication unit 101 transmits a trial synchronization request frame, and receives a trial synchronization replay frame as a reply for the trial synchronization request frame. The communication unit 101 switches the first˜N-th (N is an integral number larger than one) transmission cycle by an indication of the cycle decision unit 108, and transmits the trial synchronization request frame. The communication unit 101 transmits the trial synchronization request frame by the i-th (i is an integral number of 1˜N) transmission cycle in the trial period determined by the trial period decision unit 110. Here, the first˜N-th transmission cycle may not be previously determined, and may be indicated randomly. Furthermore, N may be an arbitrary value.

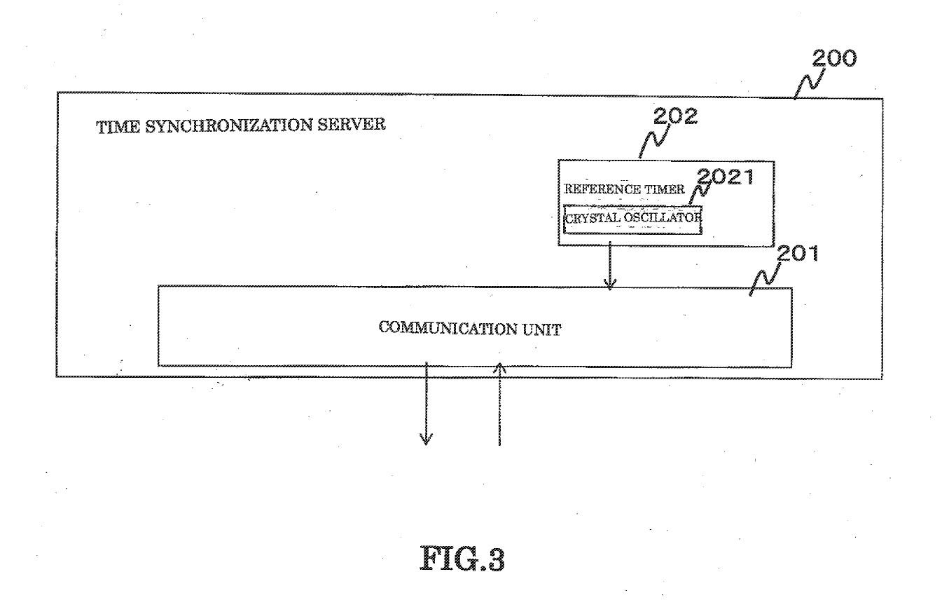

The communication unit 101 has a function to record a time stamp representing a time of the timer 102 when the synchronization request frame is transmitted, and a time stamp representing a time of the timer 102 when the synchronization reply frame is received. Furthermore, the communication unit 101 has a function to record a time stamp representing a time of the reference timer 202 (shown in FIG. 3) of the time synchronization server 200 when the time synchronization server 200 receives the synchronization request frame, and a time stamp representing a time of the reference timer 202 when the time synchronization server 200 transmits the synchronization reply frame (both time stamps are included in the synchronization replay frame). The communication unit 101 may include a storage unit to store time stamps.

The timer 102 clocks a time. Specifically, by counting a first output signal outputted at a first cycle from the crystal oscillator 1021, the timer 102 clocks the time.

The accuracy input unit 103 inputs an accuracy of the timer 102 to the reference timer 202 of the time synchronization server 200. Here, the accuracy of the timer 102 to the reference timer 202 is, for example, a difference between a first frequency of a first output signal of the crystal oscillator 1021 of the timer 102 and a second frequency of a second output signal of a crystal oscillator 2021 (shown in FIG. 3) of the reference timer 202 of the time synchronization server 200. Moreover, a value having accuracy prescribed with specification of the crystal oscillator 1021 may be inputted to the accuracy input unit 103. Furthermore, a value having accuracy compared the crystal oscillator 1021 with a high accurate clock may be inputted to the accuracy input unit 103. The accuracy may be not inputted by the accuracy input unit 103 but previously stored in the time synchronization client 100.

The allowable time difference input unit 104 inputs a time difference (allowable time difference) allowed between the timer 102 and the reference timer 202 of the time synchronization server 200. For example, the allowable time difference may be previously determined on system design. Furthermore, the allowable time difference may be not inputted by the allowable time difference input unit 104 but previously stored in the time synchronization client 100.

The allowable measurement period calculation unit 105 calculates an allowable measurement period based on the accuracy inputted to the accuracy input unit 103 and the allowable time difference inputted to the allowable time difference input unit 104. Specifically, the allowable measurement period can be calculated by dividing the allowable time difference with the accuracy. Here, the allowable measurement period may be a value which a predetermined value is subtracted from the divided value of the allowable time difference with the accuracy.

The estimated time difference calculation unit 106 calculates an estimated time difference as a difference between a time of the timer 102 and a time of the reference timer 202, for each pair of a plurality of synchronization request frames (transmitted within the allowable measurement period before a current time represented by the timer 102) and respective synchronization reply frames corresponding thereto. Based on a first time represented by the timer 102 when the time synchronization client 100 transmits a synchronization request frame, a second time represented by the reference timer 202 of the time synchronization server 200 when the time synchronization server 200 receives the synchronization request frame, a third time represented by the reference timer 202 when the time synchronization server 200 transmits a synchronization reply frame, and a fourth time represented by the timer 102 when the time synchronization client 100 receives the synchronization reply frame, the estimated time difference calculation unit 106 calculates an estimated time difference between the timer 102 and the reference timer 104. First, based on the first time, the second time, the third time and the fourth time, the estimated time difference calculation unit 106 calculates a communication delay as a half time of a round-trip time between the synchronization request frame and the synchronization replay frame. After that, by adding the communication delay to the third time, the estimated time difference calculation unit 106 estimates a time of the reference timer 202 of the time synchronization server 200 when the time synchronization client 100 receives the synchronization reply frame. After that, by subtracting the fourth time from the estimated time (by adding the communication delay to the third time), the estimated time difference calculation unit 106 calculates an estimated time difference. In case of calculating the round-trip time to calculate the communication delay, the estimated time difference calculation unit 106 may calculate the communication delay by using one-way time of a synchronization request frame transmitted within the allowable measurement period and one-way time of a synchronization reply frame as a reply of another synchronization request frame transmitted within the allowable measurement time. For example, the communication delay may be calculated by using combination of two minimum one-way times.

Furthermore, for respective trial synchronization request frames transmitted by the communication unit 101, based on a fifth time represented by the timer 102 when the communication unit 101 transmits a trial synchronization request frame, a sixth time represented by the reference timer 202 of the time synchronization server 200 when the time synchronization server 200 receives the trial synchronization request frame, a seventh time represented by the reference timer 202 when the time synchronization server 200 transmits a trial synchronization reply frame, and an eighth time represented by the timer 102 when the communication unit 101 receives the trial synchronization reply frame, the estimated time difference calculation unit 106 calculates a communication delay as a half time of a round-trip time between the trial synchronization request frame and the trial synchronization reply frame.

The correction unit 107 corrects a time of the timer 102 based on the estimated time difference calculated by the estimated time difference calculation unit 106. Specifically, the correction unit 107 adds the estimated time difference to a current time of the timer 102, and sets the addition value to the current time of the timer 102. If a plurality of synchronization request frames were transmitted within the allowable measurement period before the current time of the timer 102, based on the estimated time difference calculated by using a minimum communication delay among communication delays calculated by respective synchronization request frames and synchronization reply frames corresponding thereto, the correction unit 107 corrects the time of the timer 102.

The cycle decision unit 108 determines a transmission cycle of the synchronization request frame. Based on the allowable measurement period calculated by the allowable measurement period calculation unit 105, the cycle decision unit 108 determines a transmission cycle of the synchronization request frame. Among transmission cycles from which respective minimum communication delays are calculated (by the estimated time difference calculation unit 106) in the allowable measurement period, the cycle decision unit 108 determines the longest transmission cycle as a transmission cycle of the synchronization request frame. Specifically, first, in each allowable measurement period in a trial period, for all pairs of the trial synchronization request frame (transmitted by the communication unit 101) and the trial synchronization request frame (received by the communication unit 101) corresponding thereto, the cycle decision unit 108 selects a minimum communication delay from communication delays of all pairs (calculated by the estimated time difference calculation unit 106). Next, the cycle decision unit 108 calculates a maximum, a median or an average of minimum communication delays selected from all allowable measurement periods in the trial period. This processing is repeated for respective transmission cycles (1st˜N-th). As a result, the maximum, the median or the average of minimum communication delays is acquired for respective transmission cycles (1st˜N-th). Next, among maximums, medians or averages of minimum communication delays of respective transmission cycles (1st˜N-th), the cycle decision unit 108 selects the smallest one (maximum, median or average), and determines the transmission cycle from which the smallest one was calculated, as a transmission cycle of the synchronization request frame. If the smallest one was calculated from at least two transmission cycles among transmission cycles (1st˜N-th), the cycle decision unit 108 selects the longest transmission cycle from the at least two transmission cycles, and determines the longest transmission cycle as a transmission cycle of the synchronization request frame.

For example, whenever the respective transmission cycles (1st˜N-th) are switched, the cycle decision unit 108 sets the transmission cycle to a shorter cycle in order. Here, if a maximum, a median or an average of minimum communication delays calculated from M-th transmission cycle (M is an integral number larger than one) is equal to a maximum, a median or an average of minimum communication delays calculated from (M−1)-th transmission cycle, the cycle decision unit 108 regards the (M−1)-th transmission cycle as the longest cycle among at least two of all transmission cycles (1st˜N-th) from which the maximum, the median or the average of communication delays is the smallest, and determines the (M−1)-th transmission cycle as a transmission cycle of the synchronization request frame.

The application frame transmission cycle input unit 109 inputs transmission cycles of all frames of an application operated in the system of FIG. 1. Here, the application represents all applications on the system of FIG. 1 including application on the time synchronization client 100 and application on another device 400. The applications on the system of FIG. 1 transmit a frame in respective predetermined cycles.

The trial period decision unit 110 determines a trial period to determine a transmission cycle of the synchronization request frame. Specifically, the trial period is a least common multiple of transmission interval of transmission cycle of frames of application inputted to the application frame transmission cycle input unit 109.

FIG. 3 is a block diagram of the time synchronization server 200. The time synchronization server 200 includes a communication unit 201, a reference timer 202. The reference timer 202 includes a crystal oscillator 2021.

The reference timer 2021 in the time synchronization server 200 clocks a reference time. Specifically, by counting a second output signal outputted at a second cycle from the crystal oscillator 2021 (having an accuracy higher than an accuracy of the crystal oscillator 1021 of the timer 102 of the time synchronization client 100), the reference timer 202 clocks the reference time.

After receiving the synchronization request frame from the time synchronization client 100, the communication unit 201 transmits a synchronization reply frame having the reference time to the time synchronization client 100. Furthermore, after receiving the trial synchronization request frame from the time synchronization client 100, the communication unit 201 transmits a trial synchronization reply frame to the time synchronization client 100.

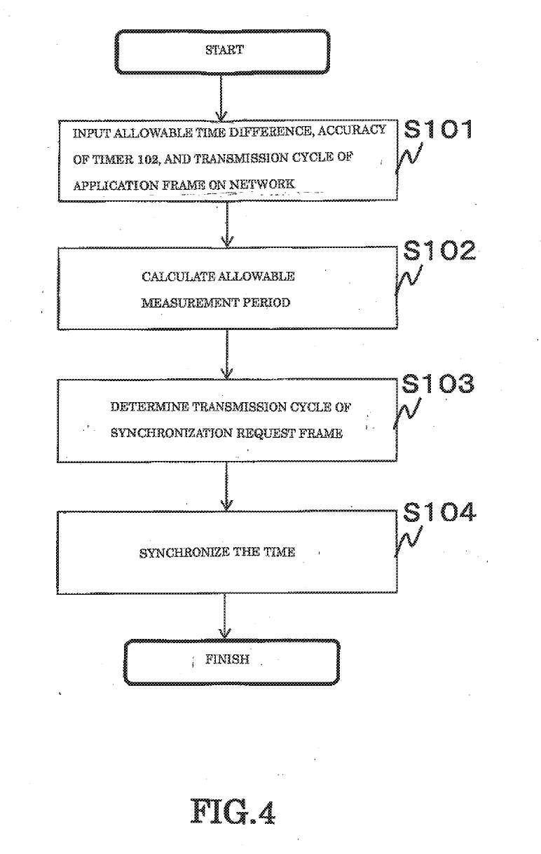

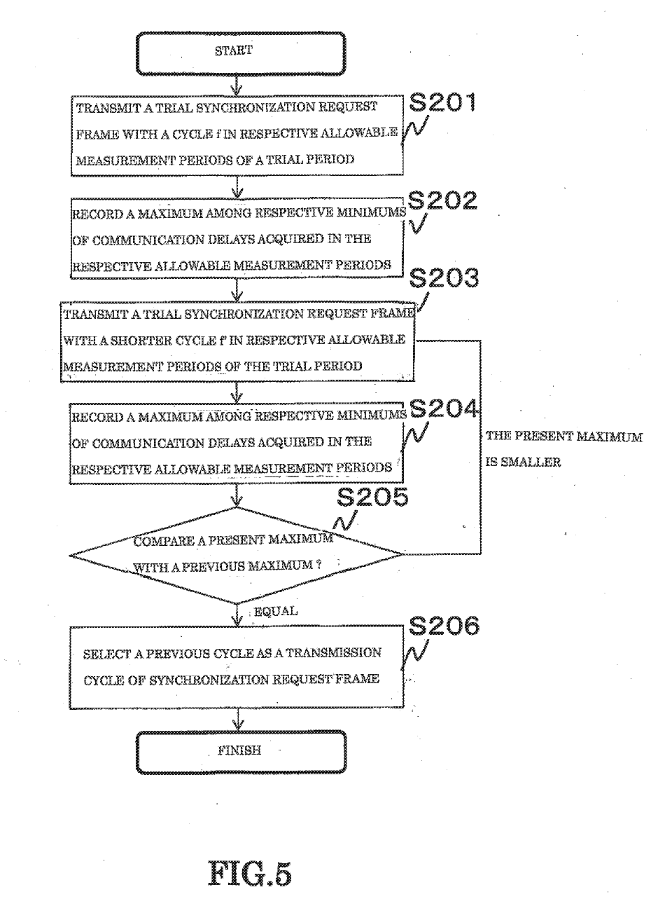

FIG. 4 is a flow chart of operation of the time synchronization client 100. FIG. 5 is a flow chart of detail operation of decision process of transmission cycle of the synchronization request frame in the flow chart of FIG. 4. By referring to FIGS. 4 and 5, operation of the time synchronization client will be explained.

First, the allowable time difference input unit 104, the accuracy input unit 103, and the application frame transmission cycle input unit 109, are in condition of input waiting respectively. When an allowable time difference is inputted to the allowable time difference input unit 104 and an accuracy of the timer 102 to the reference timer 202 is inputted to the accuracy input unit 103, these inputted values are supplied to the allowable measurement period calculation unit 105. Furthermore, a frame transmission cycle of application of system in FIG. 1 is inputted to the application frame transmission cycle input unit 109, this inputted value is supplied to the trial period decision unit 110 (S101).

Next, the allowable measurement period calculation unit 105 calculates an allowable measurement period, based on the allowable time difference and the accuracy of the timer 102 to the reference timer 202. Here, the accuracy of the timer 102 to the reference timer 202 is represented as an accuracy of the crystal oscillator 1021 to the crystal oscillator 2021. If the accuracy of the crystal oscillator 1021 to the crystal oscillator 2021 is represented by ppm (pert per million: a gap of 1 million per 1 second), the allowable measurement time is calculated as “(allowable measurement period (μ second))÷(accuracy(ppm) of the crystal oscillator 1021 to the crystal oscillator 2021)” (S102).

Next, the cycle decision unit 108 transmits trial synchronization request frames, and determines a transmission cycle of a synchronization request frame (S103).

By using the transmission cycle of the synchronization request frame determined at S103, time synchronization sequence is performed (S104).

The time synchronization sequence by using the transmission cycle of the synchronization request frame (determined at S103) will be explained.

The communication unit 101 transmits a synchronization request frame to request notification of the reference time at the transmission cycle (determined at S103) to the time synchronization server 200. The communication unit 101 receives a synchronization reply frame as a reply of respective synchronization request frames.

The estimated time difference calculation unit 106 calculates an estimated time difference as a difference between a time of the timer 102 and a time of the reference timer 202, for each pair of a plurality of synchronization request frames (transmitted within the allowable measurement period before a current time represented by the timer 102) and respective synchronization reply frame corresponding thereto.

Specifically, Based on a first time t1 represented by the timer 102 when the time synchronization client 100 transmits a synchronization request frame, a second time t2 represented by the reference timer 202 of the time synchronization server 200 when the time synchronization server 200 receives the synchronization request frame, a third time t3 represented by the reference timer 202 when the time synchronization server 200 transmits a synchronization reply frame as a reply of the synchronization request frame, and a fourth time t4 represented by the timer 102 when the time synchronization client 100 receives the synchronization reply frame, the estimated time difference calculation unit 106 calculates a communication delay by using an equation (1). Then, by adding the communication delay to the third time t3 (the reference time represented by the reference timer 202), the estimated time difference calculation unit 106 estimates a time of the reference timer 202 of the time synchronization server 200 when the time synchronization client 100 receives the synchronization reply frame. After that, by subtracting the fourth time t4 (a time of the timer 102 when the time synchronization client 100 receives the synchronization reply frame) from the estimated time (by adding the communication delay to the third time) of the reference timer 202 of the time synchronization server 200 when the time synchronization client 100 receives the synchronization reply frame, the estimated time difference calculation unit 106 calculates an estimated time difference (equation (2)).

communication delay={(t4−t3)+(t2−t1)}/2 (1)

estimated time difference=(t3+communication delay)−t4 (2)

Based on the estimated time difference calculated by using a minimum communication delay among communication delays calculated for each pair of synchronization request frames (transmitted within the allowable measurement period before the current time of the timer 102) and respective synchronization reply frames corresponding thereto, the correction unit 107 corrects the time of the timer 102. Specifically, by adding the estimated time difference to the current time of the timer 102, the time of the timer 102 is corrected. The above is explanation of the time synchronization sequence.

Next, detail step of decision (S103) of transmission cycle of the synchronization request frame will be explained by referring to FIG. 5.

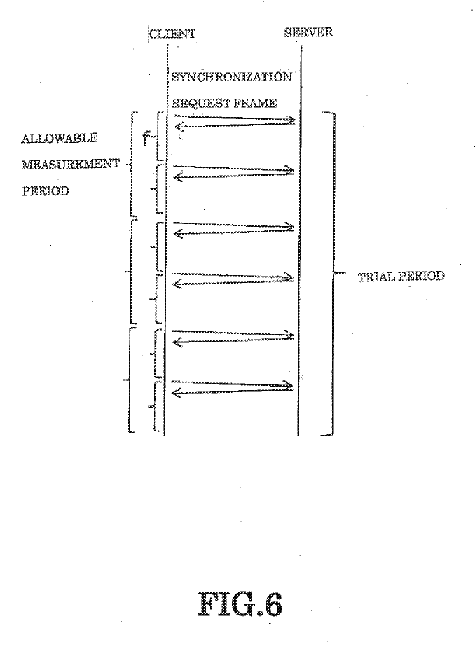

First, the cycle decision unit 108 sets a transmission cycle f to the communication unit 101, and the communication unit 101 transmits a trial synchronization request frame at the transmission cycle f in a trial period (S201). Here, the transmission cycle f is a cycle to transmit at least one time in the allowable measurement period (FIG. 6 shows relationship among the trial period, the allowable measurement period, and the transmission cycle f). Furthermore, the trial period decision unit 110 sets the trial period as a least common multiple of transmission intervals (inputted to the application frame transmission cycle input unit 109) of all applications to transmit frames on system of FIG. 1. The reason why the trial period is the least common multiple of transmission intervals of all applications will be explained afterwards.

Next, the trial period is segmented by the allowable measurement period. In each segment, a round-trip time is calculated as the sum of a transmission time (outward) of the trial synchronization request frame and a transmission time (return) of the trial synchronization reply frame, and a minimum communication delay is calculated as a half value of the round-trip time. Then, by comparing minimum communication delays of respective allowable measurement periods (segmented), a maximum (the largest value) is recorded (S202). In this case, a pair of outward and return may be not one continuous round-trip but a pair of a minimum transmission time (outward) and a minimum transmission time (return) respectively selected from a plurality of continuous round-trips. As the reason why the minimum communication delay is selected from communication delays of respective allowable measurement periods, error of calculation result of communication delay due to effect of queueing delay of communication network device can be the smallest during the allowable measurement period. As the reason why the maximum is selected from minimum communication delays of all allowable measurement periods in the trial period, the largest error occurred by a plurality of synchronization processing at the transmission cycle of the synchronization request frame is calculated. Moreover, among minimum communication delays of respective allowable measurement periods, not the maximum but an average or a median may be recorded.

Next, the cycle decision unit 108 sets a transmission cycle f′ (shorter than f) to the communication unit 101, and the communication unit 101 transmits a trial synchronization request frame at the transmission cycle f′ in the trial period (S203). Furthermore, the trial period decision unit 110 sets the trial period as a least common multiple of transmission intervals (inputted to the application frame transmission cycle input unit 109) of all applications to transmit frames on a communication network including a system of FIG. 1.

Next, in the same way as S202, the cycle decision unit 108 records the maximum among minimum communication delays of all allowable measurement periods in the trial period (S204).

Next, the cycle decision unit 108 compares two communication delays (a present maximum and a previous maximum) recorded at S202 and S204 (S205).

If the communication delay (the present maximum) recorded at present time is smaller (S205), processing is returned to S203. If the communication delay (the present maximum) recorded at present time is equal to the communication delay (the previous maximum) recorded at previous time (S205), processing is forwarded to S206. Furthermore, if the communication delay (the present maximum) recorded at present time is larger than the communication delay (the previous maximum) recorded at previous time, processing is forwarded to S206.

The transmission cycle used at previous trial synchronization processing is selected as a transmission cycle of synchronization frame (S206).

The reason why, if the present maximum is equal to the previous maximum, the transmission cycle used at previous trial synchronization processing is selected, will be explained. Even if the transmission cycle of synchronization frame is further shortened, only traffic due to the synchronization request frame is increased. In this case, the minimum communication delay calculated at the transmission cycle of the synchronization request frame in the allowable measurement period cannot be further reduced.

In operation flow chart of FIG. 5, the transmission cycle f is shortened in order whenever trial synchronization processing is performed. However, a method to change the transmission cycle is not limited to this method. It may be effectively decided that the minimum communication delay calculated at the transmission cycle of the synchronization request frame in the allowable measurement period cannot be further reduced. For example, at S203, the transmission cycle may be shortened in order so that the number of frames in the allowable measurement period is increased one by one. Furthermore, at S203, the transmission cycle may be changed at random. Furthermore, by reducing the transmission cycle one by half, if the present maximum is equal to the previous maximum at S205, the transmission cycle is returned to a median between the present cycle and the previous cycle. Then, the transmission cycle is repeatedly reduced one by half. Namely, the transmission cycle may be systematically changed.

Furthermore, as the reason why the trial period is the least common multiple of transmission intervals of all applications, a minimum period that the synchronization request frame covers all combination patterns of background traffics in the trial period is specified. If the trial synchronization processing is performed in this minimum period, all traffic patterns are covered. Accordingly, after that, even if the trial synchronization processing is repeated many times, the same result is acquired. This method is especially effective that applications transmitted on communication network are always fixed such as industrial or substation-communication network.

Moreover, for example, the system of FIG. 1 is a synchronization system applied to a protection relay system. In this case, the time synchronization client 100 and the time synchronization server 200 in FIG. 1 are protection relay. However, the present embodiment is not limited to the protection relay system.

As mentioned-above, according to the time synchronization client 100 of the first embodiment, the allowable measurement period is calculated from an accuracy difference between the reference timer 202 and the timer 102, and the allowable time difference. The estimated time difference is calculated from a minimum communication delay calculated within the allowable measurement period before the current time, and time synchronization is performed by using the estimated time difference. Accordingly, the time synchronization can be realized in a range of error allowed for the time synchronization system. Furthermore, even if component of the time synchronization system is changed, by using the accuracy difference (between the reference timer 202 and the timer 102) and the allowable time difference, an allowable measurement period peculiar to this system is calculated. Accordingly, the time synchronization can be easily realized in a range of error allowed for the respective time synchronization systems. Furthermore, according to the time synchronization client 100 of the first embodiment, after the allowable measurement period is calculated, while a transmission cycle of the trial synchronization request frame is changed, the transmission cycle of the synchronization request frame is searched so that the minimum communication delay in the allowable measurement period is not further reduced. As a result, by calculating the suitable communication delay, the time synchronization having few errors can be realized.

For example, the time synchronization client 100 can be realized by using a general purpose computer device as a basic hardware. Namely, the communication unit 101, the timer 102, the accuracy input unit 103, the allowable time difference input unit 104, the allowable measurement period calculation unit 105, the estimated time difference calculation unit 106, the correction unit 107, the cycle decision unit 108, the application frame transmission cycle input unit 109, and the trial period decision unit 110, are realized by executing a program with a processor loaded onto above-mentioned computer device. Here, the time synchronization client 100 may be realized by previously installing the program into the computer device. Furthermore, by storing the program into a storage device such as CD-ROM, or by distributing the program via the communication network, the time synchronization client 100 may be realized by suitably installing the program into the computer device.

### The Second Embodiment

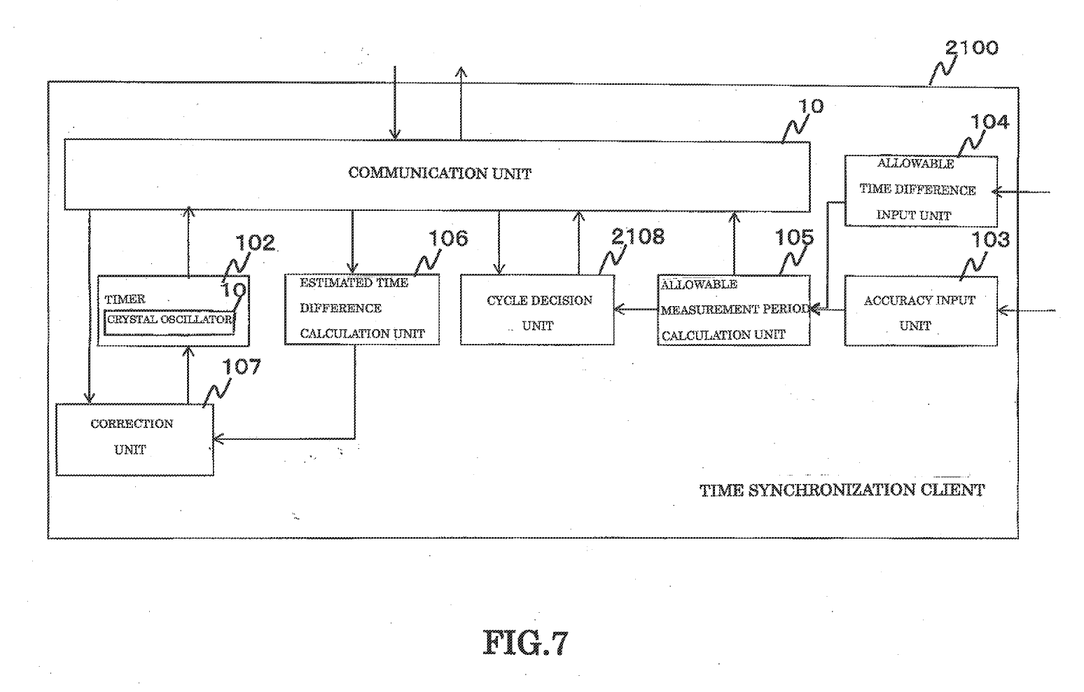

FIG. 7 is a block diagram of a time synchronization client 2100 according to the second embodiment.

In the time synchronization client 2100 of the second embodiment, a method for determining the transmission cycle of the synchronization request frame is different from that of the time synchronization client 100 of the first embodiment.

In the time synchronization client 2100 of the second embodiment, the number of synchronization request frames to be transmitted in the allowable measurement period is previously set. Accordingly, a transmission cycle of the synchronization request frame can be determined based on the allowable measurement period (calculated by the allowable measurement period calculation unit 105) and the number of synchronization request frames previously set in the allowable measurement period.

In the time synchronization client 2100 of the second embodiment, a function of a cycle decision unit 2108 is different from a function of the cycle decision unit 108 of the time synchronization client 100 of the first embodiment. Furthermore, the time synchronization client 2100 does not include the application frame transmission cycle input unit 109 and the trial period decision unit 110.

The cycle decision unit 2108 determines the transmission period of the synchronization request frame, based on the allowable measurement period and the number of synchronization request frames to be transmitted in the allowable measurement period.

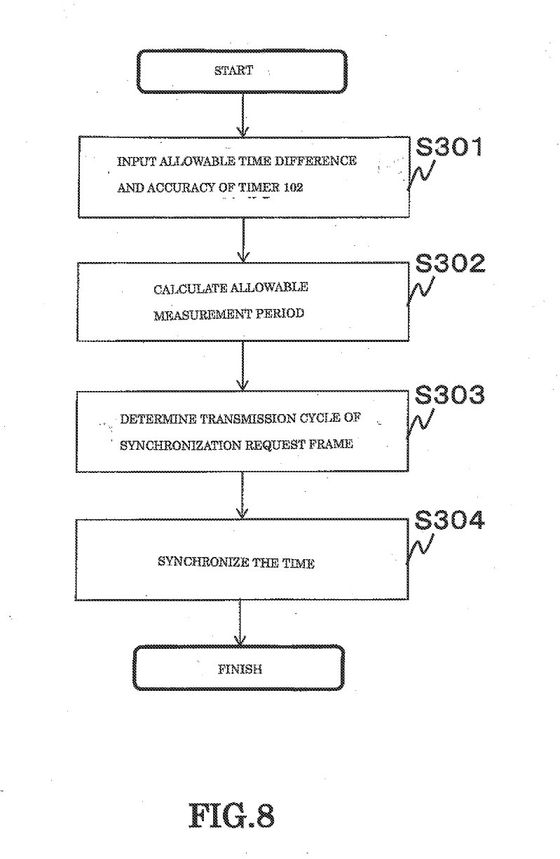

Next, by referring to FIGS. 7 and 8, operation of the time synchronization client 2100 will be explained. FIG. 8 is a flow chart of operation of the time synchronization client 2100.

First, the allowable time difference input unit 104 and the accuracy input unit 103 are in condition of input waiting respectively. When an allowable time difference is inputted to the allowable time difference input unit 104 and an accuracy of the timer 102 to the reference timer 202 is inputted to the accuracy input unit 103, these inputted values are supplied to the allowable measurement period calculation unit 105 (S301).

Next, the allowable measurement period calculation unit 105 calculates an allowable measurement period, based on the allowable time difference and the accuracy of the timer 102 to the reference timer 202. Here, the accuracy of the timer 102 to the reference timer 202 is represented as an accuracy of the crystal oscillator 1021 to the crystal oscillator 2021. If the accuracy of the crystal oscillator 1021 to the crystal oscillator 2021 is represented by ppm (pert per million: a gap of 1 million per 1 second), the allowable measurement time is calculated as “(allowable measurement period(μ second))÷(accuracy (ppm) of the crystal oscillator 1021 to the crystal oscillator 2021) ” (S302).

Next, the cycle decision unit 2108 determines a transmission cycle of the synchronization request frame from the allowable measurement period (calculated at S302) and the number of synchronization request frames previously determined in the allowable measurement period (S303). Here, the transmission cycle of the synchronization request frame can be calculated by dividing the allowable measurement period with the number of synchronization request frames previously determined in the allowable measurement period.

By using the transmission cycle of the synchronization request frame determined at S303, time synchronization sequence is performed (S304). The time synchronization sequence is same as the method explained at S104 of the first embodiment. Accordingly, the explanation is omitted.

According to the time synchronization client 2100 of the second embodiment, from the allowable measurement period and the number of synchronization request frames to be transmitted in the allowable measurement period, the transmission cycle of the synchronization request frame is determined. Accordingly, in the time synchronization client 2100 of the second embodiment, in the same way as the first embodiment, even if component of the time synchronization system is changed, the time synchronization can be easily realized in a range of error allowed for the respective time synchronization systems. Furthermore, in the time synchronization client 2100 of the second embodiment, the transmission cycle of the synchronization request frame can be easily determined.

As effect of at least one of embodiments explained above, in the time synchronization system including the time synchronization client and the time synchronization server, even if component of the time synchronization system is changed, the time synchronization can be easily realized in a range of error allowed for the time synchronization system.

For example, the time synchronization client 2100 can be realized by using a general purpose computer device as a basic hardware. Namely, the communication unit 101, the timer 102, the accuracy input unit 103, the allowable time difference input unit 104, the allowable measurement period calculation unit 105, the estimated time difference calculation unit 106, the correction unit 107, and the cycle decision unit 2108, are realized by executing a program with a processor loaded onto above-mentioned computer device. Here, the time synchronization client 2100 may be realized by previously installing the program into the computer device. Furthermore, by storing the program into a storage device such as CD-ROM, or by distributing the program via the communication network, the time synchronization client 2100 may be realized by suitably installing the program into the computer device.

While certain embodiments have been described, these embodiments have been presented by way of examples only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A time synchronization client comprising:
a communication unit that transmits a plurality of request frames to request a notification of a reference time to a server having a reference timer that clocks the reference time, and receives a reply frame as a reply of respective request frames from the server;
a timer that clocks a time;
an allowable measurement period calculation unit that calculates an allowable measurement period, based on an accuracy of the timer to the reference timer and an allowable time difference between the timer and the reference timer;
an estimated time difference calculation unit that calculates an estimated time difference between the timer and the reference timer for the respective request frames transmitted within the allowable measurement period before a current time of the timer, based on a first time of the timer when the communication unit transmits the request frame, a second time of the reference timer when the server receives the request frame, a third time of the reference timer when the server transmits the reply frame, and a fourth time of the timer when the communication unit receives the reply frame; and
a correction unit that corrects the time of the timer, based on the estimated time difference.

2. The time synchronization client according to claim 1, wherein
the estimated time difference calculation unit calculates a communication delay as a half of a round-trip time of each pair of the respective request frames and the reply frame thereof, based on the first time, the second time, the third time and the fourth time, and calculates the estimated time difference by using the communication delay, and
the correction unit corrects the time of the timer, based on the estimated time difference calculated by using a minimum communication delay among communication delays of all pairs of the respective request frames and the replay frame thereof.

3. The time synchronization client according to claim 2, further comprising:
a cycle decision unit that determines a transmission cycle of the request frame, based on the allowable measurement period.

4. The time synchronization client according to claim 3, wherein
the cycle decision unit determines the transmission cycle as the longest transmission cycle among transmission cycles at which minimum communication delays are calculated in respective allowable measurement periods.

5. The time synchronization client according to claim 4, wherein
the communication unit transmits a trial synchronization request frame, and receives a trial synchronization reply frame as a reply of the trial synchronization request frame,
the cycle decision unit switches the first˜N-th (N is an integral number larger than one) transmission cycle, and makes the communication unit transmit the trial synchronization request frame at the i-th (i is an integral number of 1˜N) transmission cycle in a first trial period,
the estimated time difference calculation unit calculates the communication delay as a half of a round-trip time of each pair of respective trial synchronization request frames and the trial synchronization reply frame thereof, based on a fifth time of the timer when the communication unit transmits the trial synchronization request frame, a sixth time of the reference timer when the server receives the trial synchronization request frame, a seventh time of the reference timer when the server transmits the trial synchronization reply frame, and an eighth time of the timer when the communication unit receives the trial synchronization reply frame, and
the cycle decision unit selects a minimum communication delay from communication delays of all pairs of the respective trial synchronization request frames and the trial synchronization reply frame thereof in respective allowable measurement periods of the first trial period, calculates a maximum, a median or an average of minimum communication delays in the respective allowable measurement periods of the first trial period, and determines the transmission cycle of the request frame as the longest transmission cycle among at least two transmission cycles at which the maximum, the median or the average is the smallest among the maximum, the median or the average of minimum communication delays calculated respectively at the first˜N-th transmission cycles.

6. The time synchronization client according to claim 5, further comprising:
an application frame transmission cycle input unit that inputs a transmission cycle of a frame of an application operated on a communication network including the time synchronization client and the server; and
a trial period decision unit that determines the first trial period as a least common multiple of transmission intervals of the frame of the application, based on the transmission cycle of the frame of the application.

7. The time synchronization client according to claim 6, wherein
the cycle decision unit, when the first˜N-th transmission cycles are switched, shortens the respective transmission cycles in order, and, if the maximum, the median or the average of minimum communication delays calculated at the M-th (M is an integral number larger than one) transmission cycle is larger than or equal to the maximum, the median or the average of minimum communication delays calculated at the (M−1)-th transmission cycle, determines the transmission cycle of the request frame as the (M−1)-th transmission cycle by regarding as the longest transmission cycle among at least two transmission cycles at which the maximum, the median or the average is the smallest among the maximum, the median or the average of minimum communication delays calculated respectively at the first˜N-th transmission cycles.

8. The time synchronization client according to claim 7, wherein
the time synchronization client is a protection relay.

9. The time synchronization client according to claim 1, wherein
the timer clocks the time by counting a first output signal outputted at a first cycle from a first crystal oscillator,
the reference timer of the server clocks the reference time by counting a second output signal outputted at a second cycle from a second crystal oscillator having a higher accuracy than the first crystal oscillator, and
the accuracy of the timer to the reference timer is a difference between the first cycle and the second cycle.

10. The time synchronization client according to claim 3, wherein
the cycle decision unit determines the transmission cycle of the request frame, based on the allowable measurement period and the number of request frames to be transmitted in the allowable measurement period.

11. A system including a client and a server each for time synchronization,
the server comprising a reference timer that clocks a reference time, and
the client comprising:
a communication unit that transmits a plurality of request frames to request a notification of a reference time to the server, and receives a reply frame as a reply of respective request frames from the server;
a timer that clocks a time;
an allowable measurement period calculation unit that calculates an allowable measurement period, based on an accuracy of the timer to the reference timer and an allowable time difference between the timer and the reference timer;
an estimated time difference calculation unit that calculates an estimated time difference between the timer and the reference timer for the respective request frames transmitted within the allowable measurement period before a current time of the timer, based on a first time of the timer when the communication unit transmits the request frame, a second time of the reference timer when the server receives the request frame, a third time of the reference timer when the server transmits the reply frame, and a fourth time of the timer when the communication unit receives the reply frame; and
a correction unit that corrects the time of the timer, based on the estimated time difference.

12. A non-transitory computer readable medium for causing a computer to perform operations for controlling a time synchronization client, the operations comprising:
transmitting a plurality of request frames to request a notification of a reference time to a server having a reference timer that clocks the reference time;
receiving a reply frame as a reply of respective request frames from the server;
calculating an allowable measurement period, based on an accuracy of a timer of the time synchronization client to the reference timer and an allowable time difference between the timer and the reference timer;
calculating an estimated time difference between the timer and the reference timer for the respective request frames transmitted within the allowable measurement period before a current time of the timer, based on a first time of the timer when the time synchronization client transmits the request frame, a second time of the reference timer when the server receives the request frame, a third time of the reference timer when the server transmits the reply frame, and a fourth time of the timer when the time synchronization client receives the reply frame; and
correcting a time of the timer of the time synchronization client, based on the estimated time difference.
